(19) United States
(12) Patent Application Publication
(10) Pub. No.: US 2016/0330411 A1
(43) Pub. Date: Nov. 10, 2016

(54) Camera assembly and method for sharing public surveillance data.

(71) Applicant: ALEXANDER FAVORS, Albrightsville, PA (US)

(72) Inventor: ALEXANDER FAVORS, Albrightsville, PA (US)

(21) Appl. No.: 14/703,738

(22) Filed: May 4, 2015

(51) Int. Cl. H04N 7/18; G08B 13/196

(52) U.S. Cl. CPC H04N 7/183; G08B 13/19619

(57) ABSTRACT

A personally owned, public surveying camera assembly that captures and stores public images, video, and audio for allowing anyone within range of the camera assembly to freely and wirelessly download the stored image data, video data, and audio data. The camera assembly also has a dedicated website for anyone to download optional camera data downloading software and for the owner of the camera assembly to register the location of the camera assembly. The camera assembly freely allows uniformed and marked law enforcement to enter onto the camera assembly owner's property, but not enter into the camera assembly owner's facility unless permission has been granted, for entering into the range of the camera assembly's Wi-Fi transceiver, infrared diodes, Bluetooth transceiver, or USB port for downloading data.

### BACKGROUND OF THE INVENTION

Surveillance cameras and surveillance closed circuit television systems disclosed in numerous prior art are great for viewing and recording public scenes, but lacks the ability to promptly share its recorded video data, image data, or audio data with individuals investigating a public incident. And in some situations, access to the recorded data is non-existent. This is due to the recorded data is stored on a secured or inaccessible storage drive. Therefore, if an individual investigating a public incident does not own the secured storage drive, personal or legal permission is needed to access the secured recorded data. Seeking personal or legal permission to access the secured storage drive takes time, which diminishes the probability of apprehending the perpetrator in the public incident. The present disclosed invention eliminates the delay to access the recorded stored data by providing a camera assembly that constantly and openly allows anyone within the vicinity of the camera's Wi-Fi transceiver antenna, infrared diodes, Bluetooth transceiver antenna, or USB port to copy its recorded picture data, video data, and audio data.

### BRIEF SUMMARY OF THE INVENTION

The invention as claimed is a personally owned public surveillance camera assembly that openly allows anyone in the vicinity of the camera to copy its recorded picture data, video data, and audio data. The invention as claimed contains a camera, housing, microphone, a magnetometer chip, a processor, application software, data storage drive, Wi-Fi transceiver, infrared diodes, Bluetooth transceiver, USB port, a Real-Time-Clock, a Global Positioning System receiver, a dedicated website, visual and audio recording status indicators.

### BRIEF DESCRIPTION OF THE DRAWINGS

FIG. 1 illustrates the external parts of the camera assembly.

FIG. 2 illustrates the external parts of the camera assembly with the housing partially cut away to show the internal parts.

FIG. 3 is a flowchart illustrating the camera assembly onboard application software infrared communication routine.

FIG. 4 is a flowchart illustrating the camera assembly onboard application software universal serial bus communication routine.

FIG. 5 is a flowchart illustrating the camera assembly onboard application software IEEE 802.11 (Wi-Fi) communication routine.

FIG. 6 is a flowchart illustrating the camera assembly onboard application software Bluetooth communication routine.

FIG. 7 & FIG. 8 is a flowchart illustrating the camera assembly onboard application software video data recording, picture data recording, audio data recording, time synchronization, compass synchronization, and recording monitoring routine.

### DETAILED DESCRIPTION OF THE INVENTION

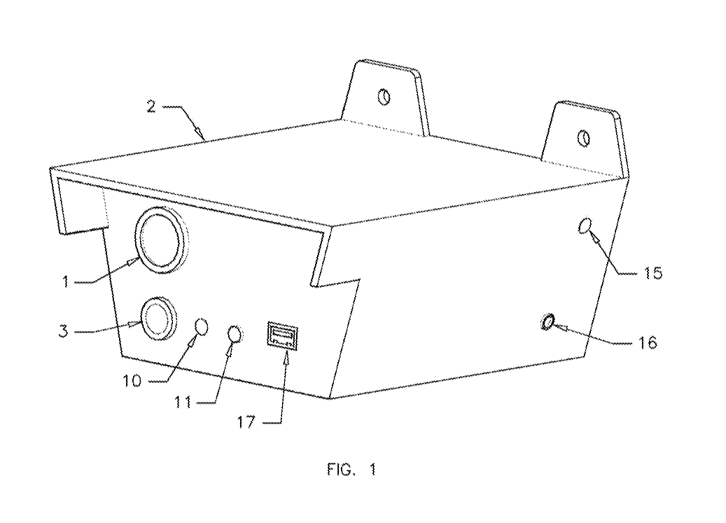

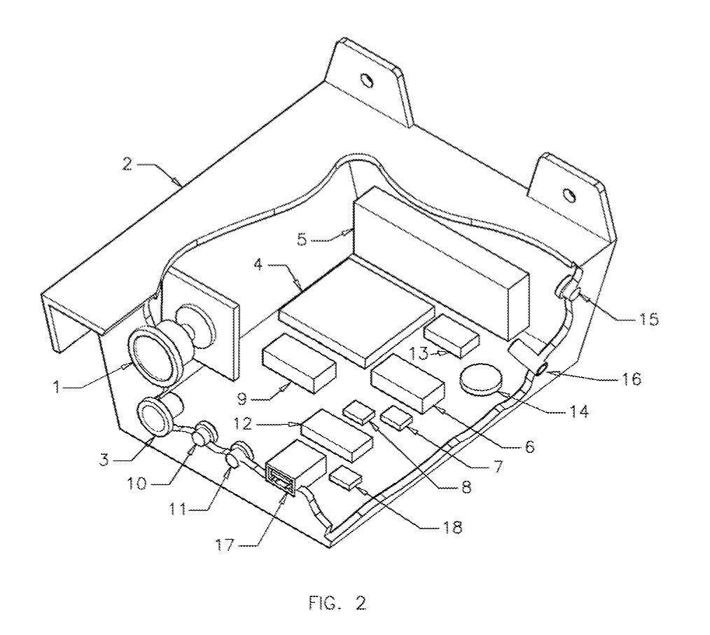

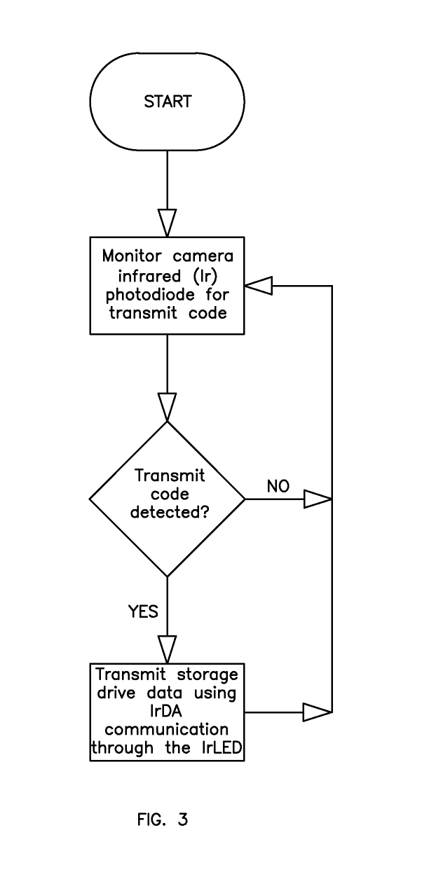

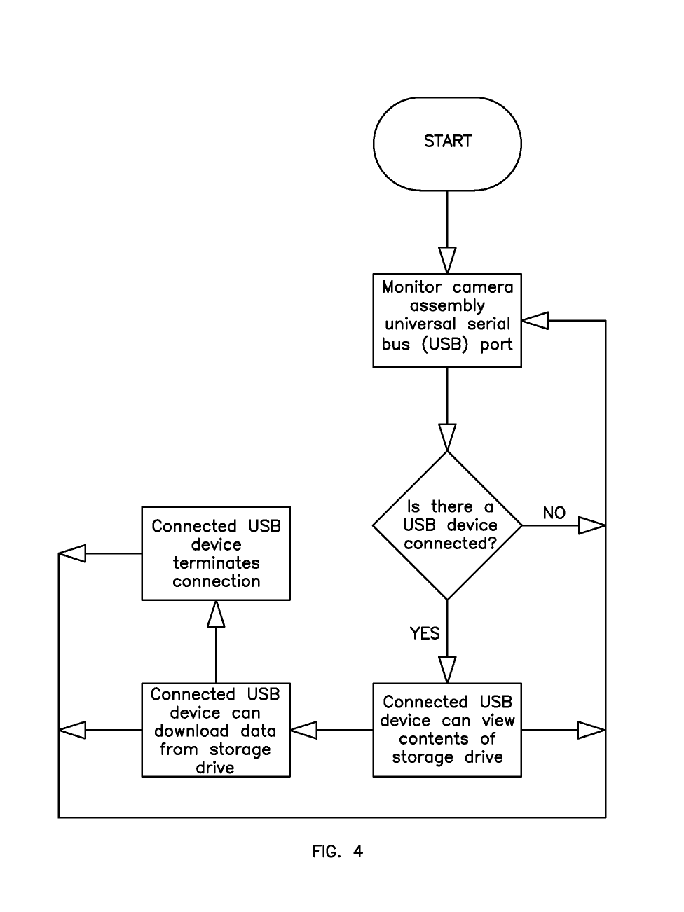

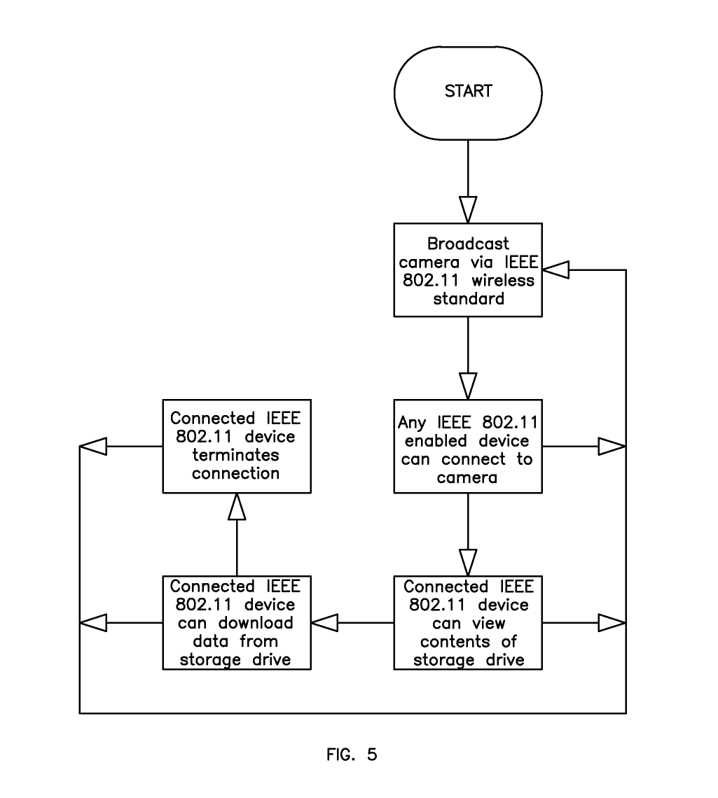

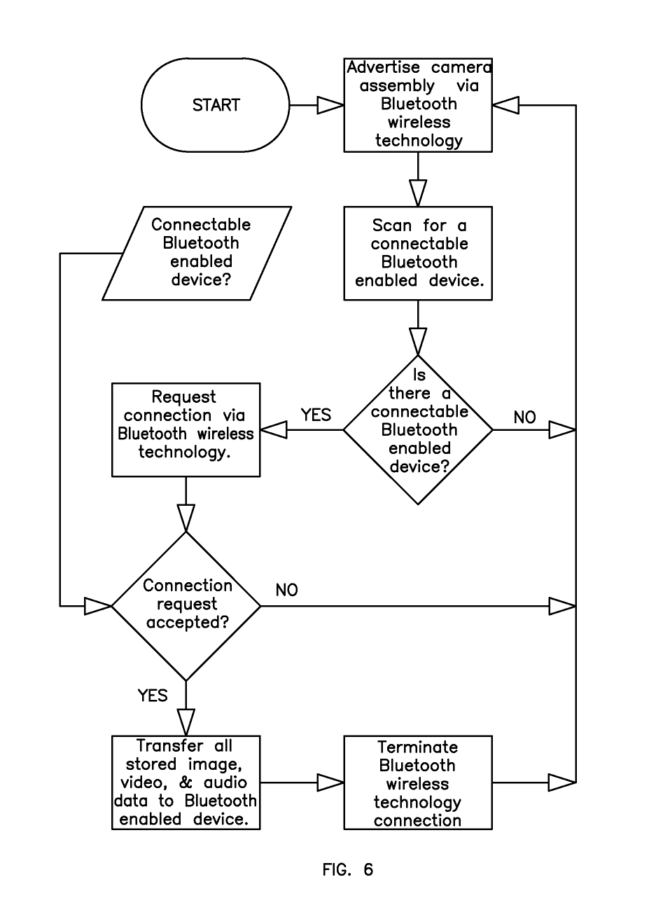

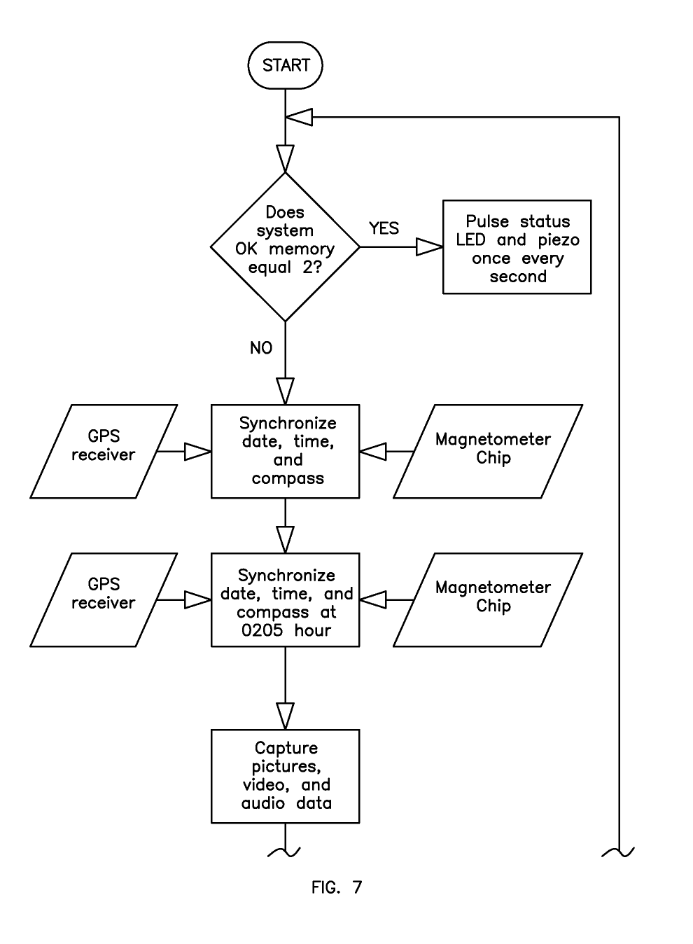

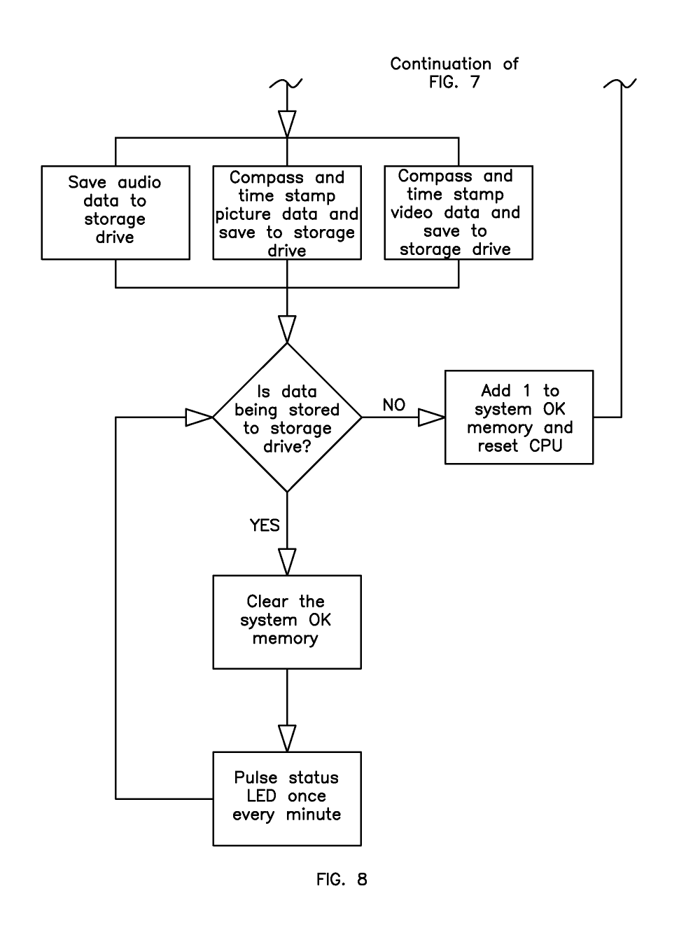

In an embodiment, the present invention is constituted of a Defender Security CCD camera, part number 82-16090, referred to as 1 in FIG. 1 & FIG. 2. The present invention is constituted of a camera assembly housing referred to as 2 in FIG. 1 & FIG. 2. The present invention is constituted of a MCM microphone, part number MCE-401 MIC, referred to as 3 in FIG. 1 & FIG. 2. The present invention is constituted of a Z3 Technology central processor unit (CPU); part numbers Z3-DM368-RPS & Z3-DM368-MOD, referred to as 4 in FIG. 2. The CPU contains the Real-Time-Clock. The CPU will employ Linux as the operating system. The present invention is constituted of a PNY Technologies data storage drive, part number P-SDU32G10-GE, referred to as 5 in FIG. 2. The present invention is constituted of a Texas Instruments Wi-Fi transceiver & Bluetooth transceiver Chip, part number WL1837MOD, referred to as 6 in FIG. 2. The present invention is constituted of a Texas Instruments Wi-Fi Antenna, part number W3006, referred to as 7 in FIG. 2. The present invention is constituted of a Texas Instruments Bluetooth Antenna, part number W3006, referred to as 8 in FIG. 2. The present invention is constituted of a Unitrode infrared transceiver, part number UCC5343, referred to as 9 in FIG. 2. The present invention is constituted of a HP infrared LED, part number HSDL 4220, referred to as 10 in FIG. 1 & FIG. 2. The present invention is constituted of a Vishay photodiode, part number BPV22NF, referred to as 11 in FIG. 1 & FIG. 2. The present invention is constituted of a Texas Instruments Global Positioning System receiver chip, part number GPS CC4000-TC6000OGN, referred to as 12 in FIG. 2. The present invention is constituted of a Texas Instruments piezo & LED driver, part number TPS61040, referred to as 13 in FIG. 2. The present invention is constituted of a Multicomp piezo, part number ABT-441-RC, referred to as 14 in FIG. 2. The present invention is constituted of a Multicomp LED, part number OVL-3324, referred to as 15 in FIG. 1 & FIG. 2. The present invention is constituted of a Switchcraft power jack receptacle to accept 12 volts direct current from a step-down transformer, part number 722A, referred to as 16 in FIG. 1 & FIG. 2. The present invention is constituted of a Molex Universal Serial Bus (USB) port, part number 48258-0001, referred to as 17 in FIG. 1 & FIG. 2. The present invention is constituted of an STMicroelectronics magnetometer chip, part number LIS3MDL, referred to as 18 in FIG. 2. The present invention is constituted of a web site for allowing the owner of the camera assembly to register the location of the camera assembly and for downloading optional software that would allow the user of the camera to obtain customize downloadable data from the camera assembly.

1. A personally owned, publicly displayed, public surveying camera assembly comprising of a camera, assembly housing, microphone, processor, application software, data storage drive, Wi-Fi (IEEE 802.11) transceiver, infrared LED, infrared photodiode, Bluetooth transceiver, and USB port which after being powered on, the camera constantly records and stores pictures, video, and audio whereas the stored picture data, video data, and audio data are constantly and openly accessible to anyone within the range of the camera assembly's Wi-Fi transceiver, infrared LED, infrared photodiode, Bluetooth transceiver, and USB port for downloading the data to their Wi-Fi enabled, Bluetooth enabled, infrared enabled, or USB enabled device.

2. The camera assembly of claim 1, wherein the camera assembly is configured with a Real-Time-Clock for time stamping the video and picture data images.

3. The camera assembly of claim 1, wherein the camera assembly is configured with a Global Positioning System receiver for time synchronization.

4. The camera assembly of claim 1, wherein the camera assembly has a dedicated website for the owner of the camera assembly to register the location of the camera assembly and for anyone to download optional camera data downloading applications.

5. The camera assembly of claim 1, wherein the camera assembly is configured with a magnetometer chip for compass stamping the video and picture data images.

6. The camera assembly of claim 1, wherein uniformed and marked law enforcement are freely allowed to enter onto the camera assembly owner's property for entering into the range of the camera assembly's Wi-Fi transceiver antenna, infrared LED, infrared photodiode, Bluetooth transceiver antenna, or USB port for downloading video, audio, and picture data.

7. The camera assembly of claim 1, wherein the camera assembly has self-diagnostic circuitry with visual and audio recording status indicators.

8. A personally owned, public surveying camera assembly that captures and stores public images, video, and audio for allowing anyone to freely download the stored public video data, picture data, and audio data.

9. The camera assembly of claim 8, wherein the camera assembly has a dedicated website for the owner of the camera assembly to register the location of the camera assembly and for anyone to download optional camera data downloading applications.

10. The camera assembly of claim 8, wherein uniformed and marked law enforcement are freely allowed to enter onto the camera assembly owner's property for entering into the range of the camera assembly's Wi-Fi transceiver antenna, infrared LED, infrared photodiode, Bluetooth transceiver antenna, or USB port for downloading video, audio, and picture data.

11. A personally owned, self-contained, public surveying camera assembly that captures and stores public images, video, and audio for allowing anyone within range of the camera assembly to freely and wirelessly download the stored image data, video data, and audio data.

12. The camera assembly of claim 11, wherein the camera assembly is configured with a magnetometer chip for compass stamping the video and picture data images.

13. The camera assembly of claim 11, wherein the camera assembly has a dedicated website for the owner of the camera assembly to register the location of the camera assembly and for anyone to download optional camera data downloading applications.

14. The camera assembly of claim 11, wherein uniformed and marked law enforcement are freely allowed to enter onto the camera assembly owner's property for entering into the range of the camera assembly's Wi-Fi transceiver antenna, infrared LED, infrared photodiode, Bluetooth transceiver antenna, or USB port for downloading video, audio, and picture data.
